(19) United States
(12) Patent Application Publication
(10) Pub. No.: US 2005/0097382 A1
(43) Pub. Date: May 5, 2005

(54) Techniques to regulate power consumption

(76) Inventors: Thorsten Schoenfelder, Harsum (DE); Finn L. Kraemer, Naerum (DK); Michael Kauschke, Braunschweig (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/700,924

(22) Filed: Nov. 3, 2003

(51) Int. Cl. G06F 1/04

(52) U.S. Cl. 713/500

(57) ABSTRACT

Briefly, a power regulator system that regulates power spikes during power-up and power-down modes.

### FIELD

The subject matter disclosed herein generally relates to techniques to regulate power consumption.

### DESCRIPTION OF RELATED ART

Currently, most large scale integration (LSI) devices are implemented using complementary metal oxide semiconductor (CMOS) technologies. A functional block implemented in CMOS may consume power in proportion to the clock rate utilized by the functional block. Thus, a considerable amount of power can be saved by disabling the operating clock of a non-operating functional block. However, an enabling or disabling operation of a functional block in a system having other functional blocks, where the other functional blocks may be operating or at rest, can cause a considerable abrupt spike in the overall system power consumption as well as a change in the supply voltage level. The supply voltage should be kept in a specified operational range at all times. It is also preferable to minimize changes in the supply voltage level. Additionally, the abrupt spike in the overall system power consumption may cause undesired crosstalk to neighboring circuitries. For example, FIG. 1 depicts a power consumption spike (power consumption signal POWER) that may occur when a clock signal is provided to an enabled functional block. FIG. 1 also depicts a change in supply voltage (signal VCC) that may occur in connection with the power consumption spike.

Currently, external blocking capacitors are used to prevent the power surge from disturbing other functional blocks of a system, whether the other functional blocks share or do not share the same power supply rail. To reduce the cost of chip manufacture, it is desirable to minimize utilization of capacitors.

### BRIEF DESCRIPTION OF THE DRAWINGS

FIG. 1 depicts an example power consumption spike and change in supply voltage;

FIG. 2 depicts an example system that includes subblocks A, B, and C;

FIG. 3 depicts a power regulator in accordance with an embodiment of the present invention;

FIG. 4A depicts an example timing diagram during a power-up mode; and

FIG. 4B depicts an example timing diagram during power-down mode.

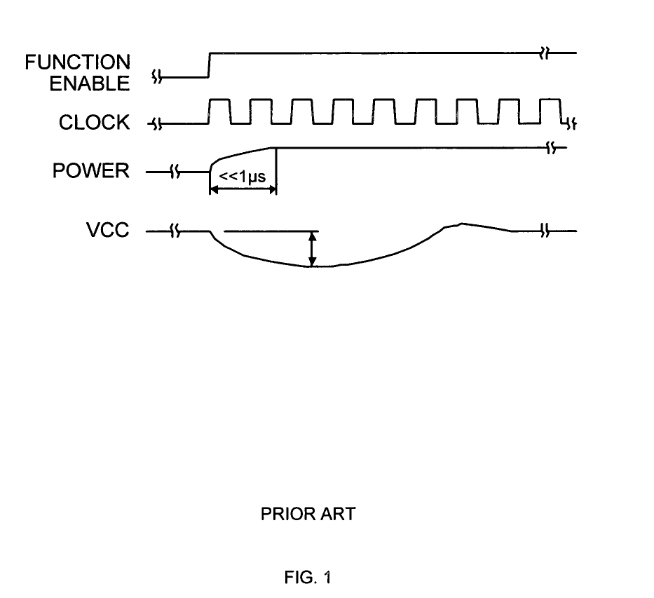

Note that use of the same reference numbers in different figures indicates the same or like elements.

### DETAILED DESCRIPTION

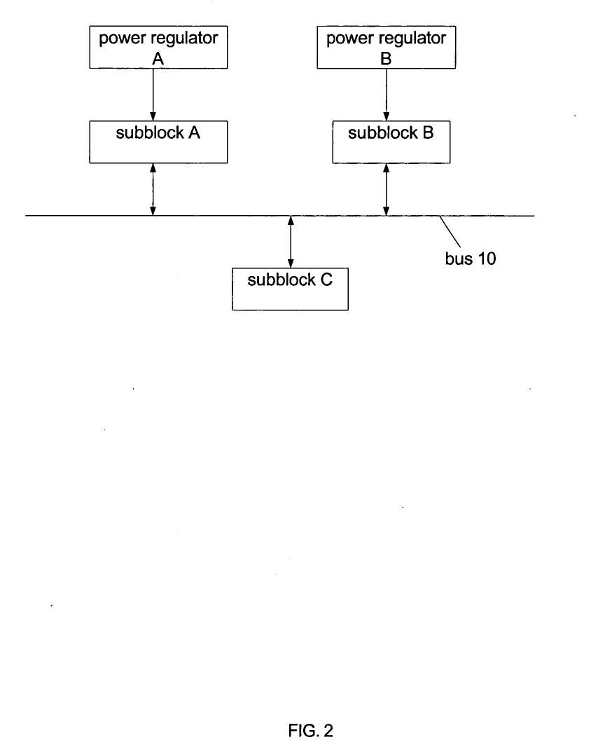

FIG. 2 depicts an example system that includes subblocks A, B, and C. Subblocks A-C can, but do not have to, share a common power supply line (not depicted). Subblocks A-C may intercommunicate using a bus 10. For example, bus 10 may comply with one or more of the following standards: Ten Gigabit Attachment Unit Interface (XAUI) (described in IEEE 802.3, IEEE 802.3ae, and related standards), Ethernet (described in IEEE 802.3 and related standards), Serial Peripheral Interface (SPI), I²C, universal serial bus (USB), IEEE 1394, Gigabit Media Independent Interface (GMII) (described in IEEE 802.3, IEEE 802.3ae, and related standards), Peripheral Component Interconnect (PCI), ten bit interface (TBI), and/or a vendor specific multi-source agreement (MSA) protocol.

In this example, each of subblocks A and B may consume significantly more power than that of subblock C. In one embodiment, subblocks A and B may use respective power regulators A and B, in accordance with some embodiments of the present invention. To reduce power peaks, power regulators A and B may regulate the rate at which clock signals are provided to respective subblocks A and B during power-up and power-down. For example, during power-up or power-down of subblock A, power regulator A may reduce power peaks that would disturb subblocks B and C whether subblocks A-C share a common power supply line or not. Likewise, during power-up or power-down of subblock B, power regulator B may avoid power peaks that would disturb subblocks A and C whether subblocks A-C share a common power supply line or not.

For example, the system of FIG. 2 may be utilized in an optical communications receiver. For example, one implementation of subblock A may reduce jitter in a received signal. For example, one implementation of subblock B may be a data processor that may perform optical transport network (OTN) de-framing and de-wrapping in compliance for example with ITU-T G.709; forward error correction (FEC) processing in compliance for example with ITU-T G.975; and/or media access control (MAC) processing in compliance for example with Ethernet. For example, one implementation of subblock C may perform a multiplexing or de-multiplexing. For example, the system of FIG. 2 may be utilized in a computer system where one implementation of subblock A may be a microcontroller, one implementation of subblock B may be a memory device, and one implementation of subblock C may be an input/output controller.

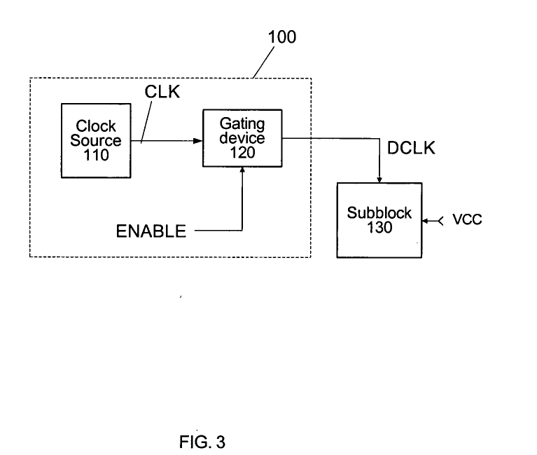

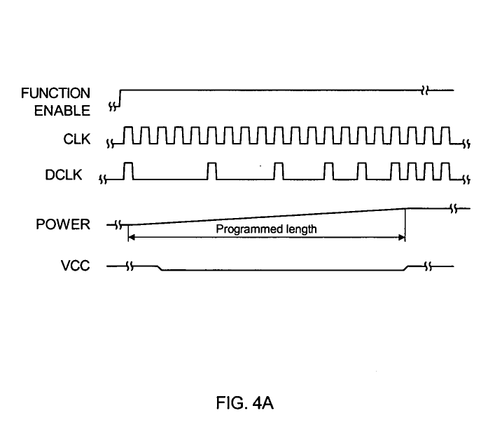

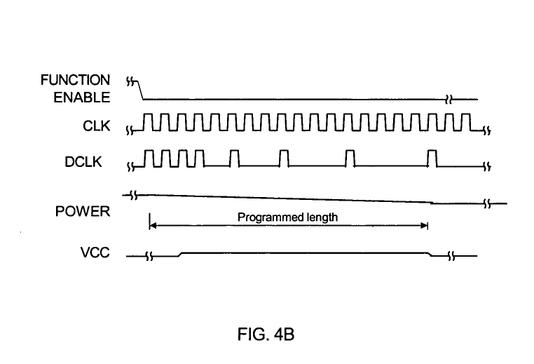

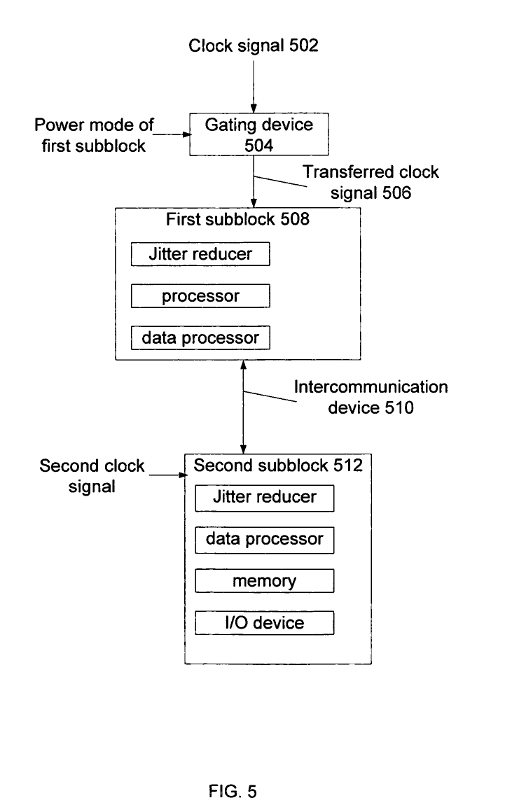

FIG. 3 depicts a power regulator 100 in accordance with an embodiment of the present invention. Power regulator 100 may regulate power consumed by a subblock 130 at least during power-up and power-down modes. For example, “power-up” mode may correspond to a time period when a clock signal is gradually provided to subblock 130 after the clock signal was not provided to the subblock 130. “Power-down” mode may correspond to a time period when a clock signal is gradually not provided to the subblock 130 after the clock signal was provided to subblock 130. FIG. 4A depicts an example timing diagram during a power-up mode whereas FIG. 4B depicts an example timing diagram during power-down mode.

One implementation of power regulator 100 may include clock source 110 and gating device 120. Power regulator 100 may regulate power consumed by subblock 130 at least during power-up and power-down modes. Subblock 130 may be a semiconductor device capable of performing any logical operations. Power regulator 100 may be implemented on the same die, ASIC, or semiconductor device (using any types of semiconductors) as subblock 130. In one implementation, clock source 110 may be implemented on a separate die, ASIC, or semiconductor device (using any types of semiconductors) from gating device 120 and subblock 130.

Clock source 110 may provide a clock signal (signal CLK) to gating device 120. Gating device 120 may provide a design clock signal (signal DCLK) in response to the signals CLK and ENABLE. Subblock 130 may use signal DCLK as a clock signal. Gating device 120 may provide as signal DCLK binary high states of signal CLK for the first cycle of every X cycles of clock signal CLK, where X is an integer and X decreases after every X cycles of clock signal CLK. The value X may be chosen to set the rate of change in power consumption during power-up mode. The value X can be initialized to any value and the amount that value X decreases can be set as constant or may change.

As shown in FIG. 4A, decreasing the rate at which a clock signal is provided reduces the peak distortion of voltage source signal Vcc. In the example timing diagram of FIG. 4A, value X is initialized to five (5) so that signal DCLK is in a binary high state the first cycle of five (5) cycles of signal CLK. After five (5) cycles of signal CLK, value X is decreased to four (4) so that signal DCLK is in a binary high state the first cycle of four (4) cycles of signal CLK, and so on until signal DCLK tracks signal CLK.

During power-down mode, value X used by gating device 120 may be initialized to any value and then increased to reach a preset maximum value, where value X may be increased by a constant or varying amount. According to the example of FIG. 4B, prior-to and at the beginning of power-down mode, binary high states of signal DCLK of gating device 120 track those of signal CLK. According to the example of FIG. 4B, the value X may be increased so that the binary high states of signal DCLK track those of signal CLK the first cycle of two (2) cycles of clock signal CLK, followed by the first cycle of three (3) cycles of clock signal CLK, and so on. As shown in FIG. 4B, changes in power consumption and peak distortion of voltage source signal Vcc can be controlled by gradually phasing out providing cycles of signal DCLK.

Modifications

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

1. An apparatus comprising:
a functional subblock element to receive a transferred clock signal; and
a gating device to selectively transfer selected zero and non-zero states of a clock signal as the transferred clock signal based on a power mode of the functional subblock element.

2. The apparatus of claim 1, wherein the gating device is to transfer selected zero and non-zero states of the clock signal as the transferred clock signal in response to a first cycle of an integer N cycles of the clock signal.

3. The apparatus of claim 2, wherein the value N decreases to a preset limit after each first cycle during power-up mode of the subblock element.

4. The apparatus of claim 2, wherein the value N increases to a preset limit after each first cycle during power-down mode of the subblock element.

5. The apparatus of claim 1, wherein the functional subblock element comprises a semiconductor device that receives a DC voltage signal.

6. The apparatus of claim 1, further comprising a clock source to provide the clock signal to the gating device.

7. The apparatus of claim 1, wherein the gating device is responsive to an enable signal to determine power-up and power-down modes of the functional subblock element.

8. A method comprising:
sensing a power mode;
selectively gradually varying power provided in response to a change in power mode, wherein the gradually varying power comprises selectively transferring first cycles of a clock signal every integer N cycles of the clock signal, wherein the integer N changes based on the power mode, and wherein the first cycles include zero and non-zero states of the clock signal.

9. (Canceled)

10. The method of claim 8, further comprising selectively decreasing the value N to a preset limit after each first cycle in response to the power mode comprising power-up mode.

11. The method of claim 8, further comprising selectively increasing the value N to a preset limit after each first cycle in response to the power mode comprising power-down mode.

12. A system comprising:
a first subblock to receive a transferred clock signal;
a gating device to selectively transfer selected zero and non-zero states of a clock signal as the transferred clock signal based on a power mode of the first subblock;
a second subblock to receive a second clock signal;
an intercommunication device to provide intercommunication between the first subblock and second subblock.

13. The system of claim 12, wherein the intercommunication device is compatible with Ten Gigabit Attachment Unit Interface (XAUI).

14. The system of claim 12, wherein the intercommunication device is compatible with Serial Peripheral Interface (SPI).

15. The system of claim 12, wherein the intercommunication device is compatible with Gigabit Media Independent Interface (GMII).

16. The system of claim 12, wherein the first subblock comprises a data processor.

17. The system of claim 16, wherein the data processor is to perform media access control in compliance with IEEE 802.3.

18. The system of claim 16, wherein the data processor is to perform optical transport network de-framing in compliance with ITU-T G.709.

19. The system of claim 16, wherein the data processor is to perform forward error correction processing in compliance with ITU-T G.975.

20. The system of claim 16, wherein the second subblock is to reduce jitter in an input signal.

21. The system of claim 12, wherein the first subblock is to reduce jitter in an input signal.

22. The system of claim 21, wherein the second subblock comprises a data processor.

23. The system of claim 12, wherein the first subblock comprises a processor.

24. The system of claim 23, wherein the second subblock comprises a memory.

25. The system of claim 23, wherein the second subblock comprises an input/output device.

26. The system of claim 12, wherein the second clock signal is based on the clock signal.
